(19) United States
(12) Patent Application Publication
(10) Pub. No.: US 2007/0169597 A1
(43) Pub. Date: Jul. 26, 2007

(54) Method and apparatus for adjusting suction of cutting machine

(76) Inventor: Toshiaki Morita, Wakayama (JP)

Correspondence Address: HARNESS, DICKEY & PIERCE, P.L.C., P.O. BOX 8910, RESTON, VA, 20195, US

(21) Appl. No.: 10/587,833

(22) PCT Filed: Jan. 26, 2005
(86) PCT No.: PCT/JP05/01011

§ 371 Date: Jul. 28, 2006

(30) Foreign Application Priority Data
Jan. 30, 2004 (JP) 2004-022583

(51) Int. Cl. B26D 1/00; B26D 7/06; B26D 5/00

(52) U.S. Cl. 83/13; 83/100; 83/74

(57) ABSTRACT

It is an object of the invention is to provide a method and a apparatus for adjusting suction of a cutting machine capable of cutting even an elastic sheet material in an appropriate compression state by suppressing fluctuation in the degree of compression of the sheet material. A set value of a suction pressure is set such that an absolute value of the suction pressure, which is a negative pressure lower than the atmospheric pressure, becomes larger as a numerical value thereof becomes larger. For one-piece cutting as shown in FIG. 1B, the set value of the suction pressure is increased since the cutting distance of an already-cut portion is increased as cutting progresses. For stacked cutting as shown in FIG. 1A, though the set value of the suction pressure is increased before parts (1a, 1b, 1c, 1d, 1e, 1f) are cut, when the cutting is moved from the part (1f) to a part (1g), the cutting distance of the already-cut portion where air leaks is reduced since the parts (1a, 1b, 1c) are covered by a sealing sheet, and the set value of the suction pressure is lowered.

### TECHNICAL FIELD

The present invention relates to a method and apparatus for adjusting suction in a cutting machine in which a sheet material such as a fabric is cut while the sheet material is held on a table under sucking.

### BACKGROUND ART

In conventional cutting machines, a sheet material that is to be cut is placed on a support face of a breathable table and is cut in a state where the sheet material is sucked down the table. A cutting head is moved on the table while the sheet material is held so as not to move easily, and the sheet material is cut with a cutting blade provided on the cutting head. A table in a cutting machine is also referred to as a cutting table or cutting bed. The support face is configured by arranging side by side the front ends of brush-like members called hard brushes. Hard brushes are made of an elastic synthetic resin or other materials. In a portion where the cutting blade is stuck, bristles of the brushes are pressed to be warped by the cutting blade, and thus the bristles move apart from the cutting blade and are not cut. When the cutting blade moves to another position, the bristles of the brushes return to the original positions and support the sheet material.

Since the sheet material is breathable, when a plurality of such sheet materials are layered and cut at the same time, the entire sheet materials are covered with a non-breathable cover sheet and sucked. In cutting, the sheet materials are cut together with the cover sheet (see Japanese Unexamined Patent Publication JP-A 60-52299 (1985), for example). It should be noted that as the sheet materials are further cut, air that is to be sucked is leaked from the cover sheet at already-cut portions, and thus a holding force on the sheet materials decreases. According to JP-A 60-52299, a control valve provided in a vacuum generator that generates a suction force is controlled such that a suction force is kept constant.

A table for holding sheet materials in a cutting machine is relatively large, and thus it is difficult to obtain a uniform suction force on the table. Furthermore, there is a time delay before control results at the portion that generates the suction force are reflected in holding of the sheet materials on the support face. Thus, a technique has been also proposed in which an adjustment of the suction force is made possible separately for a plurality of regions obtained by dividing the support face of the table, and before cutting is actually started, the suction force is controlled by predicting the movement of a cutting blade (see Japanese Unexamined Patent Publication JP-A 7-205091 (1995), for example). An object of the technique disclosed in JP-A 7-205091 is to prevent a phenomenon called thrashing, which is caused by pressure being increased and reduced in alternation in the same region that is subjected to suction after division when there is a time delay in control of the suction force.

A technique has been also proposed in which pressure sensors are installed on the entire region of the cutting bed, and when any one of the pressure sensors detects an abnormal reduction in the pressure, the cutting is immediately stopped in order to prevent abnormal cutting (see Japanese Unexamined Patent Publication JP-A 9-155794 (1997), for example).

With respect to reduction in a suction force accompanying the progress of cutting, a technique has been also proposed in which already-cut portions of sheet materials are covered by placing a non-breathable sealing sheet thereon (see Japanese Unexamined Patent Publication JP-A5-51865 (1993), for example). JP-A 05-51865 discloses a configuration in which X-direction moving portions respectively move along both side edges of a table on which sheet materials are placed, and a Y-direction moving portion moves along a guide bridge that extends between the moving portions. When a cutting head that is provided on the Y-direction moving portion cuts sheet materials, the guide bridge pulls out a sealing sheet from the cutting start side of the table, and the already-cut sheet materials are covered with the sealing sheet.

Examples of sheet materials that are to be cut with cutting machines include cushion materials and expanded foam such as seat materials for furniture and cars in addition to fabrics for clothes. There are cases in which pile fabrics or other materials are cut. These sheet materials are elastic, and thus when the sheet materials are covered with a cover sheet and is subjected to suction on the table of the cutting machines, the thickness is reduced by compression caused in accordance with a suction force. As the cutting progresses, the cover sheet is also cut along already-cut lines of parts that have been cut off, and air flows in. As leakage accompanying the progress of the cutting increases, a suction force for holding sheet materials on the table is reduced. When the suction force is reduced, a cutting blade moves the sheet materials during cutting, and thus not only decreases cutting precision, but also the degree of compression is lowered, and thus the thickness of the sheet materials on the table increases.

A method is conceivable by which a suction force is set to be large such that sheet materials can be held sufficiently even when leakage increases. However, in this method, a suction force that is more than necessary is applied to sheet materials in an initial stage of the cutting, and the sheet materials are excessively compressed. Elastic sheet materials are cut in a state where the sheet materials are not compressed uniformly but compressed non-uniformly to be warped. Thus, parts that have been cut off have different shapes between sheet materials in upper layers and sheet materials in lower layers. Accordingly, it is desirable to cut elastic sheet materials in a state where the sheet materials are not warped significantly. Furthermore, energy is wasted when an excessive suction force is always generated.

As in JP-A 60-52299, JP-A 7-205091, and JP-A 9-155794, even when feedback control is intended such that a holding force on sheet materials is kept constant by detecting suction pressure or other factors with a sensor, it is difficult to perform the feedback control as appropriate due to a time delay in the control based on the difference between the position to detect the pressure and the position of a pressure reducing source for example, and thus a thrashing phenomenon as described in JP-A 7-205091 easily occurs. When the pressure is detected in the vicinity of a cutting blade, it is possible to detect air leakage caused by cutting without much delay. However, the pressure reducing source is positioned apart, and thus it takes time to reflect results of a restoration of a suction force based on the feedback control. It is erroneously detected that the pressure is continuously reduced by leakage although a suction force is increased at the pressure reducing source, and thus feedback control for further increasing the suction force is performed. When results of an increase in the suction force at the pressure reducing source reach the position of a sensor, the pressure that is detected is significantly reduced, and the control is switched to feedback control for suppressing the suction force at the pressure reducing source. In this manner, a thrashing phenomenon easily occurs. When the pressure is detected not in the vicinity of the cutting blade but in the vicinity of the pressure reducing source, the time delay between the pressure detection and the feedback control becomes small. However, it takes time for a pressure sensor to detect a suction force that momentarily fluctuates as the cutting progresses, and thus there is a problem in terms of fast-response.

When a suction state of sheet materials is intended to be stabilized only by feedback control of the pressure, it is impossible to avoid a time delay, and thus the suction force may be rather fluctuated. When the suction force is reduced by fluctuation in the suction force, the thickness increases because compression of sheet materials is relaxed, or the sheet materials easily move upward off the table, and thus there are cases in which cutting cannot help but be stopped, for example, because a part that has been cut off is caught by a presser that presses the surface of sheet materials at a cutting blade for cutting the sheet materials or in the vicinity of the cutting blade while a cutting head moves. Even in a case where the fluctuation in the suction force does not make it difficult to continue the cutting, the fluctuation in the thickness decreases cutting precision.

Even in a case where it is possible to keep a suction force constant by ideally performing feedback control of the suction force, the thickness of the sheet materials is not necessarily kept constant. At a part surrounded by many leakage points, the degree of compression is lowered, and thus the thickness increases, so that cutting precision decreases.

As in JP-A 5-51865, even when already-cut portions are sealed by placing a sealing sheet thereon, due to mechanical restrictions in pulling out the sealing sheet or other factors, it is impossible to completely seal the vicinity of the cutting blade. Thus, even in a case where the sealing sheet is used, the thickness of sheet materials fluctuates, and it is important to suppress this fluctuation.

### DISCLOSURE OF INVENTION

It is an object of the invention to provide a method and apparatus for adjusting suction of a cutting machine capable of cutting even an elastic sheet material in an appropriate compression state, by suppressing fluctuation in the degree of compression of the sheet material.

The invention is a method for adjusting suction of a cutting machine when cutting is performed with the cutting machine in which a cutting blade is moved with respect to a table based on preset data while a sheet material is sucked and held on the table, comprising:

as cutting progresses, confirming an extent of leakage from an already-cut portion, and adjusting a suction state so as to compensate for reduction, due to the leakage, in a holding force on the sheet material on the table.

Furthermore, in the invention, it is preferable that the suction state is adjusted based on results of a cutting simulation.

Furthermore, in the invention, it is preferable that the suction state is adjusted based on a prediction accompanying the progress of cutting.

Furthermore, in the invention, it is preferable that in the cutting machine, an already-cut portion is covered with a sealing sheet so as to prevent leakage from increasing, and the suction state is adjusted in consideration of a covered state with the sealing sheet.

Furthermore, in the invention, it is preferable that the suction state is adjusted in stages as cutting progresses.

Furthermore, in the invention, it is preferable that the suction state is adjusted in stages as cutting progresses, taking a part that is cut off a sheet material as a reference.

Furthermore, the invention is a suction adjustment apparatus, of a cutting machine, for adjusting a suction state, when a sheet material is cut by moving a cutting blade based on preset data in the cutting machine in which a sheet material is sucked and held on a table, comprising:

relation storing means for storing a relation obtained by associating in advance a cut distance of an already-cut portion and an adjustment amount of a suction state compensating for an extent of leakage from the already-cut portion;

data input means for inputting data for cutting a sheet material;

distance calculating means for calculating an amount of a cut distance increased as cutting progresses, based on data input by the data input means; and

adjustment amount calculating means for calculating an adjustment amount of a suction state, in accordance with an amount of a cut distance increased calculated by the distance calculating means, and based on a relation between the cut distance and the adjustment amount of the suction state, referring to the relation storing means.

Furthermore, in the invention, it is preferable that the cutting machine comprises mask covering means for covering an already-cut portion with a sealing sheet so as to prevent leakage from increasing, and

wherein the suction adjustment apparatus further comprises mask calculating means for calculating a cut distance of a portion that is covered with the sealing sheet of the mask covering means, of the already-cut portion,

wherein the adjustment amount calculating means obtains an amount of a cut distance increased for calculating an adjustment amount of the suction state, by correcting an amount of a cut distance increased calculated by the distance calculating means, with a cut distance of a portion that is covered with the sealing sheet calculated by the mask calculating means.

Furthermore, in the invention, it is preferable that the suction adjustment apparatus further comprises:

adjustment amount display means for displaying an adjustment amount of a suction state calculated by the adjustment amount calculating means, in association with the progress of cutting of a sheet material;

modification input means for inputting a modification of an adjustment amount with respect to the adjustment amount displayed by the adjustment amount display means; and

adjustment amount modifying means for modifying an adjustment amount based on input of the modification input means.

Furthermore, the invention is a program for letting a computer function as the suction adjustment apparatus of the cutting machine according to any one of the above-described aspects.

### BRIEF DESCRIPTION OF DRAWINGS

Other and further objects, features, and advantages of the invention will be more explicit from the following detailed description taken with reference to the drawings wherein:

FIG. 1A and FIG. 1B are simplified plane views showing examples of a suction adjustment when an elastic sheet material 1 is cut with a cutting machine into a plurality of parts according to an embodiment of the invention;

FIG. 2 is a plane view showing a schematic configuration of a cutting machine 6 used for cutting the sheet material 1 in FIG. 1;

FIG. 3 is a right side view showing a schematic configuration of a cutting machine 6 used for cutting the sheet material 1 in FIG. 1;

FIG. 4 is a block diagram showing a schematic electrical configuration of a suction adjustment apparatus 30 that can adjust suction as shown in FIG. 1 in the cutting machine 6 shown in FIGS. 2 and 3;

FIG. 5 is a flow diagram showing a schematic procedure in which the sheet material 1 is cut into parts and suction is adjusted when the suction adjustment apparatus 30 shown in FIG. 4 is provided in a design system;

FIG. 6 is a flow diagram showing a schematic procedure of a method by which once marking data is created, cutting is simulated and suction is adjusted based on the results, as another embodiment of the invention; and

FIG. 7A and FIG. 7B are graphs showing an example of the relationship between a cut distance and a leakage amount measured in Step b4 in FIG. 6, and showing an example of the relationship between a cut distance and a leakage amount measured in Step b4 in FIG. 6.

### BEST MODE FOR CARRYING OUT THE INVENTION

Now referring to the drawings, preferred embodiments of the invention are described below.

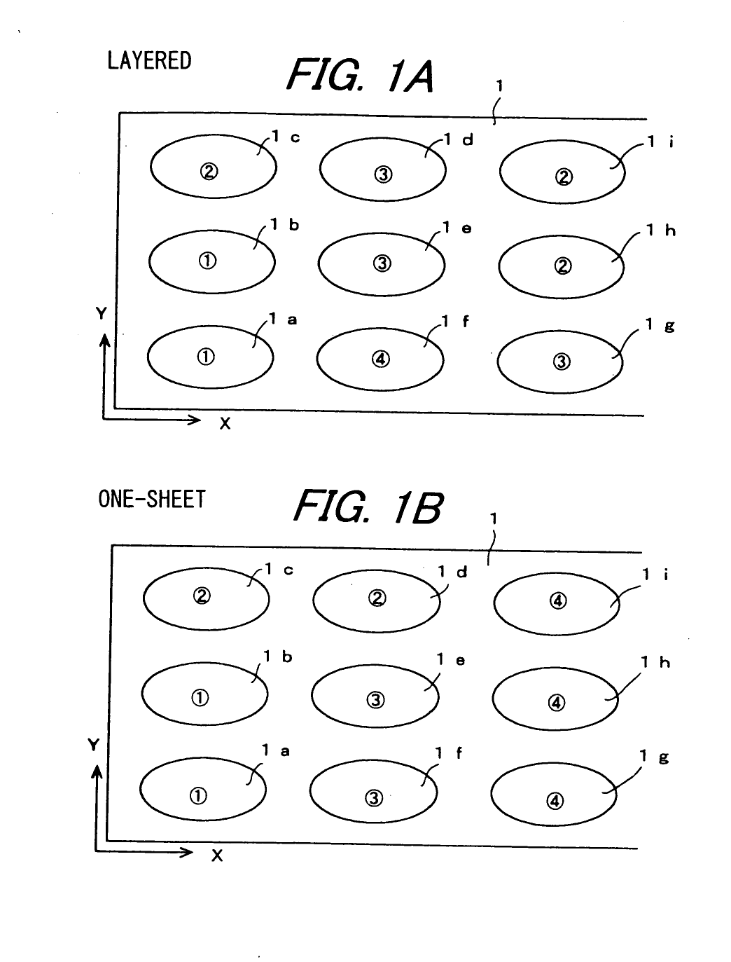

FIG. 1 shows examples of a suction adjustment when an elastic sheet material 1 is cut with a cutting machine into a plurality of parts 1a, 1b, 1c, 1d, 1e, 1f, 1g, 1h, 1i, . . . , according to an embodiment of the invention. FIG. 1A shows an example in which a plurality of sheets of sheet materials are layered and cut while already-cut portions are covered with a sealing sheet. FIG. 1B shows an example in which one sheet of sheet material is cut. The sheet material 1 is cut into the parts 1a, 1b, 1c, 1d, 1e, 1f, 1g, 1h, 1i, . . . in this order, taking the lower left end in the drawing as the origin in the X-direction and the Y-direction. For the sake of convenience, the parts 1a, 1b, 1c, 1d, 1e, 1f, 1g, 1h, 1i, . . . in the description have the same shape, but in an actual state, the parts have different shapes, and the parts 1a, 1b, 1c, 1d, 1e, 1f, 1g, 1h, 1i, . . . are arranged closer to each other in order to improve the yield rate. Values indicated for the respective parts 1a, 1b, 1c, 1d, 1e, 1f, 1g, 1h, 1i, . . . in the drawing refer to set values of the suction pressure.

Table 1 below shows an example of the relation between set values and actually obtained suction pressures. The suction pressure is gauge pressure indicated on the basis of atmospheric pressure. Although the suction pressure is negative pressure, the value is indicated as an absolute value thereof. The set values are determined for the sake of convenience, and can be set between nine stages of one to nine, for example.

TABLE 1

| | Set value | | | | | | | | |
|---|---|---|---|---|---|---|---|---|---|
| | 1 | 2 | 3 | 4 | 5 | 6 | 7 | 8 | 9 |
| Suction | 11.1 | 12.6 | 14.2 | 15.8 | 18.4 | 19.9 | 21.5 | 23.1 | 24.7 |
| pressure | | | | | | | | | |
| [kPa] | | | | | | | | | |
| (Suction | (1120) | (1280) | (1440) | (1600) | (1860) | (2020) | (2180) | (2340) | (2500) |
| pressure | | | | | | | | | |
| [mmH₂O]) | | | | | | | | | |

As shown in Table 1, as the set value of suction pressure becomes larger, the absolute value of the suction pressure as negative pressure reduced from atmospheric pressure increases. In a case where one sheet is cut as shown in FIG. 1B, as cutting progresses, a cut distance of already-cut portions increases, and thus the set value of the suction pressure is increased. In a case where layered sheets are cut as shown in FIG. 1A, the set value of the suction pressure is increased until the parts 1a, 1b, 1c, 1d, 1e, and 1f have been cut. However, when the cutting is shifted from the part 1f to the part 1g, the parts 1a, 1b, and 1c are covered with a sealing sheet, and thus a cut distance of air leaking portions of the already-cut portions decreases, and thus the set value of the suction pressure is reduced.

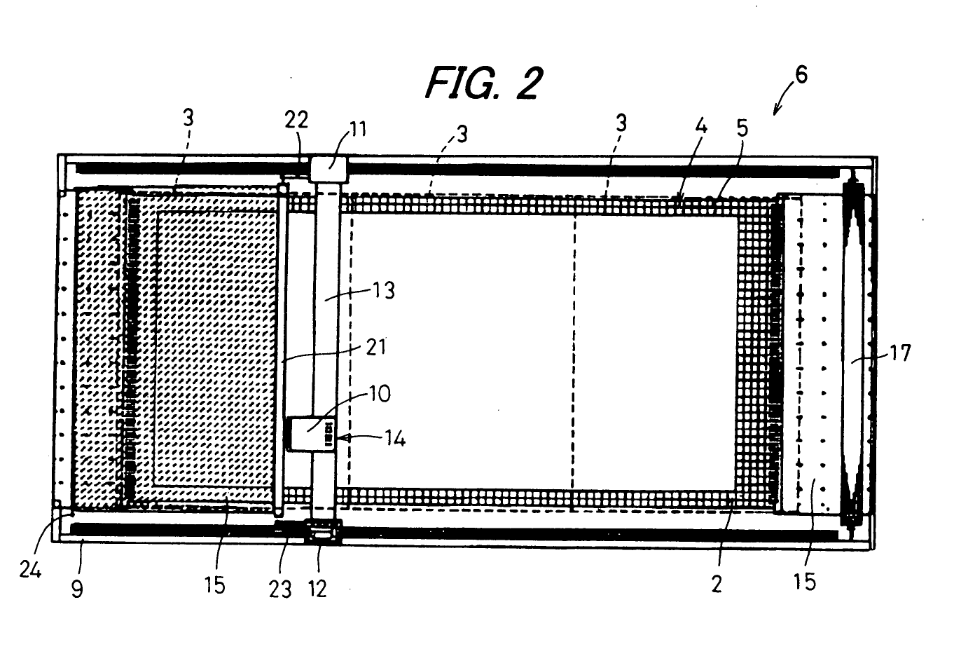

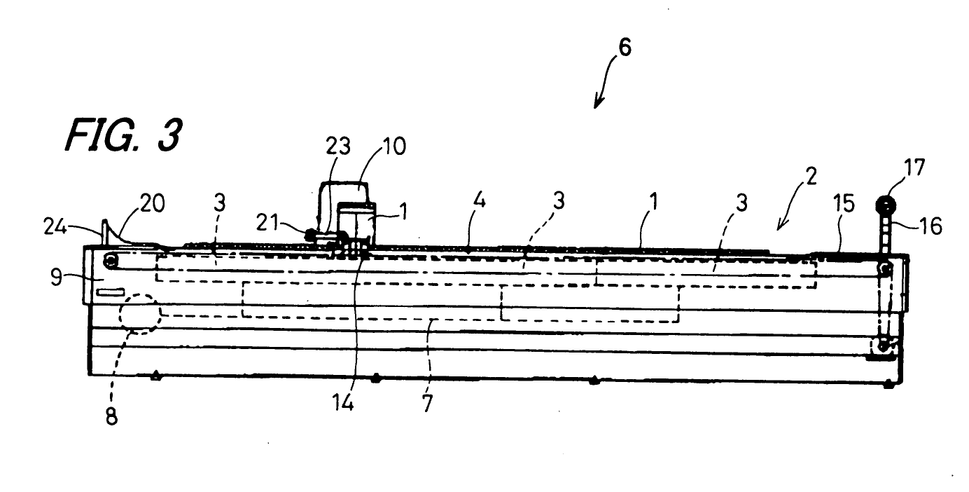

FIGS. 2 and 3 show a schematic configuration of an apparatus used for cutting the sheet material 1 in FIG. 1. FIG. 2 shows a cross-sectional view and FIG. 3 shows a side view. A table 2 is internally provided with a suction box 3, and supports the sheet material 1 that is placed on a cutting support face 4 on the front face. The cutting support face 4 is constituted by the front ends of a plurality of hard brushes 5, and can hold the sheet material 1 thereon by a suction force of the suction box 3. In a cutting machine 6 provided with this table, air inside the suction box 3 is sucked by a suction apparatus 8 via a suction duct 7. The suction apparatus 8 is provided with a blower and other components, and can control the suction pressure in stages by performing rotation number control of a motor of the blower in accordance with the set values in Table 1. The rotation number control is performed by, for example, controlling the frequency of an inverter. The suction pressure can be controlled by shifting the power of the motor or by changing channels in the suction duct 7, for example. The table 2 is provided on an upper portion of a base frame 9, and the suction duct 7 and the suction apparatus 8 are provided inside the base frame 9.

The sheet material 1 is cut by moving a cutting head 10 along the surface of the table 2 in two dimensions, that is, in the X-direction and the Y-direction. Although not shown in the drawing, the table 2 has a conveyer mechanism, and can transport a sheet material on the cutting support face 4. This transport direction is referred to as a negative direction in the X-direction. The sheet material 1 is transported from the upstream side in the transport direction onto the table 2, and the transportation is stopped in a state where the entire sheet material 1 is spread over the cutting support face 4, and holding by suction is started. After the cutting has been completed, the parts and the remaining sheet material are transported out from the downstream side in the transport direction.

X-direction moving portions 11 and 12 are provided so as to be movable back and forth along both side edges of the table 2. The X-direction moving portions 11 and 12 on both sides are coupled by a guide bridge 13. The guide bridge 13 functions also as a linear guide rail extending in the Y-direction, and the cutting head 10 can move thereon back and forth in the Y-direction. A cutting blade 14 projects from the cutting head 10 toward the cutting support face 4. The sheet material 1 is cut by repeatedly moving the cutting blade 14 back and forth on a straight line, for example. The cutting head 10 can move in two-dimensions, that is, in the X-Y-directions on the table 2, by moving the X-direction moving portions 11 and 12 in the X-direction and moving the cutting head 10 in the Y-direction along the guide bridge 13. The cutting head 10 is provided also with a mechanism to change the orientation of the cutting blade 14, and the cutting blade 14 can freely cut the sheet material 1.

When the sheet materials 1 are transported onto the cutting support face 4, the surface of the layered sheet materials 1 is covered with a cover sheet 14. The cover sheet 14 is a non-breathable film made of a synthetic resin, and supplied from a sheet roll 17 supported at a stand 16 disposed upright on the transport-in side on the table 2 to the surface of the sheet materials 1. The cover sheet 14 is cut together with the sheet materials 1 by the cutting blade 14.

In the sheet materials 1, portions that have been already cut by the cutting blade 14 increase as the cutting progresses. In order to prevent air leakage from the already-cut portions, a portion between the guide bridge 13 and the transport-out side on the table 2 is covered with a non-breathable sealing sheet 20. The sealing sheet 20 is also a synthetic resin film, for example, and is reeled off a roller 27 that is held by the guide bridge 13. The roller 27 is supported by brackets 22 and 23 projecting from the guide bridge 13 toward the transport-out side, and reeling-off and winding-up are performed by a mechanism that operates in conjunction with movement of the X-direction moving portions 11 and 12. This mechanism is described in detail in JP-A 05-51865(1993). The roller 27 is positioned closer to the transport-out side than the cutting blade 14, and thus in a space between the roller 27 and the cutting blade 14, even already-cut portions cannot be covered with the sealing sheet 20. It should be noted that a non-breathable sheet similar to the sealing sheet 20 can be used also on the transport-in side, and when the cutting blade 14 has moved closer to the transport-in side than already-cut portions during cutting, it is possible to reduce air leakage.

In principle, cutting is performed while moving the cutting head 10 from the transport-out side to the transport-in side on the table. When the sheet materials 1 that are spread over the table 2 have been completely cut, suction is stopped and the sheet materials 1 are transported to the transport-out side using the table 2 as a conveyer. Since the suction is stopped, compression of the sheet materials 1 is stopped, and the thickness of the sheet materials 1 returns to the original state. The guide bridge 13 holding the cutting head 10 moves to the transport-out side in synchronization with the transportation on the table 2. When the guide bridge 13 moves to the transport-out side and the cutting is further continued, the sheet materials 1 are supplied from the transport-in side in accordance with the transportation on the table 2. When suction is again started and the cutting is continued, the cutting blade 14 can cut sheet materials on the table 2 in the X-direction for a length longer than the length of the table 2 in the X-direction. This cutting method is called advance cutting. When the cutting is completed, the cutting head 10 is raised and the cutting blade 14 is pulled out of the sheet materials 1 whose thickness is to return to the original state.

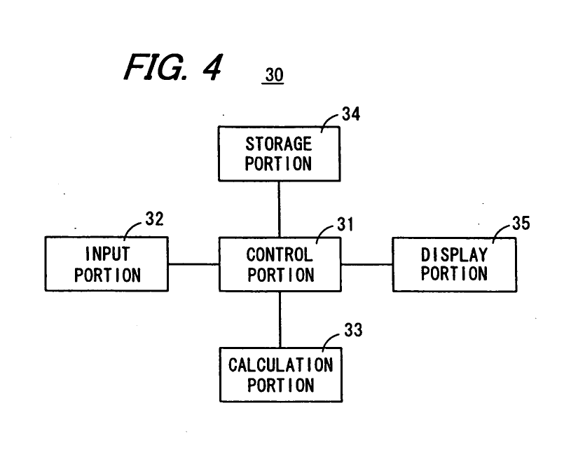

FIG. 4 shows a schematic electrical configuration of a suction adjustment apparatus 30 that can adjust suction as shown in FIG. 1 in the cutting machine 6 shown in FIGS. 2 and 3. The suction adjustment apparatus 30 includes a control portion 31, an input portion 32, a calculation portion 33, a storage portion 34, and a display portion 35. The suction adjustment apparatus 30 can be installed as a part of the controller function of the cutting machine 6, or can be realized as a part of a design system for creating marking data for cutting the sheet material 1 into the parts 1a, 1b, 1c, Id, 1e, 1f, 1g, 1h, 1i, . . . . Furthermore, it is also possible to realize the apparatus as an independent control system. Needless to say, when the apparatus is realized as the design system or the control system, it is possible to realize the apparatus as a program using a general-purpose computer apparatus. The program can be stored in a storage medium and read by the computer apparatus, or can be downloaded from an information communication network.

The control portion 31 performs overall control for adjusting suction in accordance with a program that has been created in advance. Cutting data indicating parts that are to be cut off in the design system is input to the input portion 32, and marking data is input from the design system in the cutting machine. The calculation portion 33 calculates a cut distance, and a cut distance of already-cut portions that are covered with sealing sheet 20, for example. The relation between a cut distance of already-cut portions and a set value of suction pressure compensating for an amount of leakage increased, and other items are stored in the storage portion 34 as table data or in a database. Set values of the suction pressure and other items are displayed on the display portion 35. It is possible for an operator to modify set values by inputting data to the input portion 32 while looking at the display on the display portion 35.

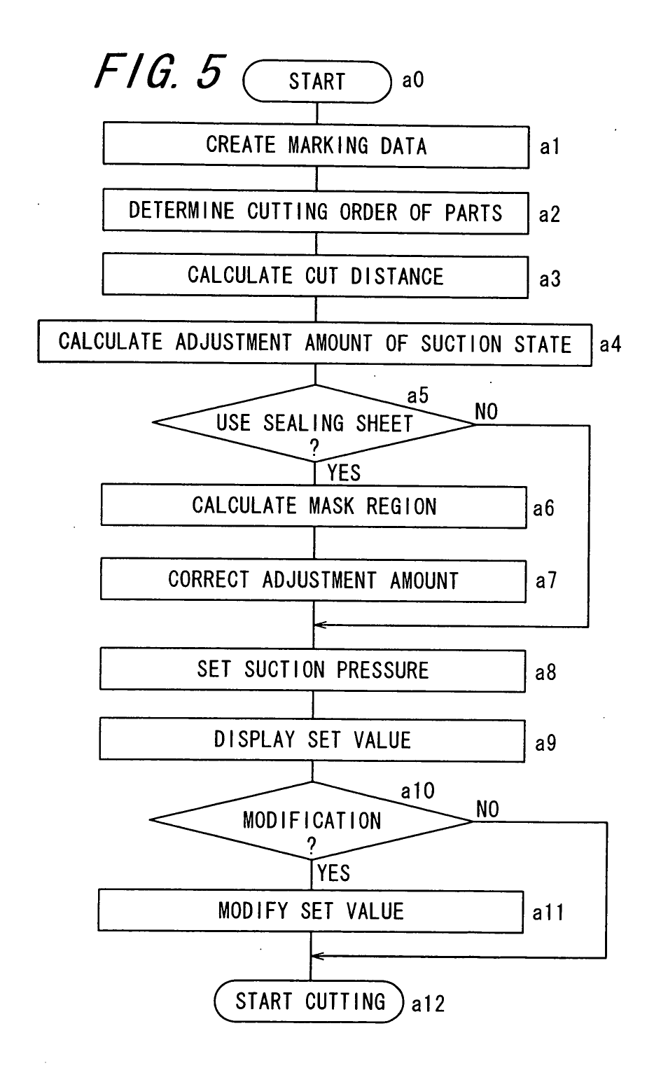

FIG. 5 shows a schematic procedure in which the sheet material 1 is cut into parts and suction is adjusted when the suction adjustment apparatus 30 shown in FIG. 4 is provided in a design system. When there is no data for cutting the sheet material 1 into parts, the procedure is started in Step a0, and data called marking data for cutting the sheet material 1 into parts is created in Step a1. The marking data is created such that the sheet material 1 can be cut into parts at a good yield rate. When a pattern is applied to the sheet material 1, the arrangement of parts is determined also in consideration of the pattern. In Step a2, the cutting order of parts is determined. The cutting order of parts is started from the origin position as shown in FIG. 1, first proceeds in the Y-direction, then proceeds in the X-direction, and again proceeds in the Y-direction, for example. However, some parts may not be cut off as appropriate in the principle procedure due to the relationship with surrounding parts. In this case, the cutting order of the parts is modified. In Step a3, as distance calculating means, the calculation portion 33 in FIG. 4 calculates a cut distance in a case where parts are continuously cut off following the cutting order. It is possible to calculate the cut distance by obtaining and adding cut lengths along cut lines of the parts. In Step a4, referring to the relation in the database of the storage portion 34 as relation storing means, the calculation portion 33 functioning as adjustment amount calculating means calculates the adjustment amount of the suction state corresponding to the cut distance.

In Step a5, the control portion 31 judges whether or not to use the sealing sheet 20. In a case where the cutting data indicates that a plurality of sheets of sheet materials 1 are cut at the same time, then the sealing sheet 20 is used, and thus the procedure proceeds to Step a6. In Step a6, the calculation portion 33 functions as mask calculating means, and calculates a mask region that is covered with the sealing sheet 20. In Step a7, the calculation portion 33 functions as adjustment amount calculating means, and corrects the adjustment amount of the suction pressure in a state where the sealing sheet 20 is not used, in consideration of the condition that the mask region is covered with the sheet material 20. After the correction has been completed in Step a7, or in a case where it is judged not to use the sealing sheet 20 in Step a5, then the suction pressure corresponding to the adjustment amount of the suction pressure is set in Step a8. As described above, a set value of the suction pressure is set in stages of one to nine, for example. In Step a9, a set value of the suction pressure is displayed for each part, for example. FIG. 1 is one example of the display. In Step a10, it is judged whether or not the operator modifies the set value. The modification is performed with respect to the input portion 32, and in a case where the modification is performed, the set value is modified in Step a11. After the process has been completed in Step a11, or in a case where no modification is performed in Step a10, then cutting is started in Step a12.

When the procedure shown in FIG. 5 is performed using the design system, the start of cutting in Step a12 refers to the start of actual cutting. The set value of the suction pressure is used for controlling the suction apparatus 8 and other devices as the cutting progresses, and fluctuation in a compression state of the sheet material 1 is suppressed by changing in stages the set value for each part or for each part group as shown in FIG. 1. When the procedure as shown in FIG. 5 is performed with the cutting machine 6, marking data in Step a1 is created by the design system, and thus the marking data is input in Step a1. The start of cutting in Step a12 also refers to the start of control of the suction pressure of the suction apparatus 8 based on the set value of the suction pressure.

It is also possible that the procedure from Step a3 to Step a8 is omitted, a default set value for each part is displayed in Step a9, and the operator determines the set values for all parts manually in effect. When the operator manually sets the values, the set values are determined in consideration of factors such as experiences and predictions of the operator.

In any case, the cutting machine 6 moves the cutting blade 14 with respect to the table 2 based on preset data while sucking and holding the sheet material 1 on the table 2. According to the method for adjusting suction, in a case where cutting is performed with the cutting machine 6, as the cutting progresses, the extent of leakage from already-cut portions is confirmed based on considerations of the operator, or calculation or data analysis using the suction adjustment apparatus 30 for example, and the suction state is adjusted so as to compensate for reduction, due to the leakage, in a holding force on the sheet material 1 on the table 2, and thus it is possible to cut even the elastic sheet material 1 in an appropriate compression state, by suppressing fluctuation in the degree of compression of the sheet material 1.

Furthermore, the suction state is adjusted in stages as the cutting progresses, and thus it is possible to reduce the control burden by suppressing fluctuation in a compression state of the sheet material 1 within a tolerance range thereby reducing the number of suction adjustments.

Furthermore, the suction state is adjusted in stages as the cutting progresses taking parts that are cut off the sheet material 1 as a reference. It is possible to adjust suction at the moment the cutting blade 14 moves apart from the sheet material 1 between parts, and thus the adjustment can be easily arranged. Needless to say, it is also possible to adjust suction at a point on apart. Here, there is a time delay before results of the suction adjustment are reflected as a change in the suction pressure, and thus suction is adjusted based on a prediction. Since cutting is performed based on cutting data, it is possible to predict time necessary to adjust suction based on the cutting speed, by confirming a time delay necessary to control the suction pressure. It is preferable that suction is adjusted at the moment the cutting blade 14 moves apart from a sheet between parts or a point on a part. Thus, when an adjustment is performed in which a suction state is changed between a current part and a next part, the adjustment is started around at the second half of the cutting of the current part, so that the cutting and the suction adjustment can be successively performed. Needless to say, it is also possible to reliably adjust suction by stopping the cutting and standing by until results of the suction adjustment are reflected. It is also possible to divide the table 2 into a plurality of zones, and to change the set value of the suction adjustment based on the zone to which the cut position belongs.

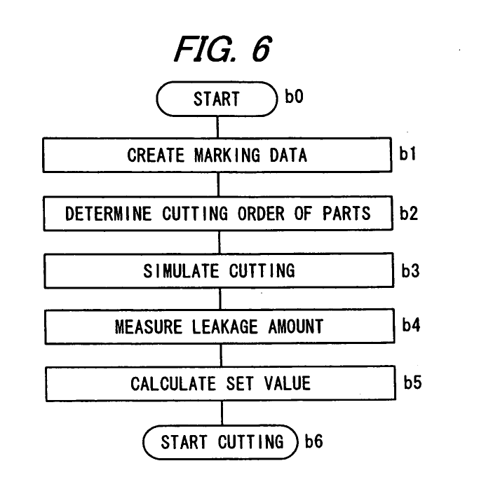

FIG. 6 shows a schematic procedure of a method by which once marking data is created, cutting is simulated and suction is adjusted based on the results, as another embodiment of the invention. Steps b0 to b2 are basically similar to Steps a0 to a2 in FIG. 4. In Step b3, cutting is simulated. In the cutting simulation, it is also possible to perform cutting under the same conditions with respect to marking data and the cutting order, using a sheet material different from the sheet material 1 that is to be actually cut, that is, using paper or other materials when the sheet material 1 is an elastic sponge material. In Step b4, an amount of air leaked is measured as the cutting progresses. It is possible to directly measure the amount of air leaked, for example, as an increased flow rate of air that is sent into the suction box 3 in order to keep the pressure inside the suction box 3 constant. However, since there is a time delay in control when changing an amount of air sent in, it is difficult to perform the measurement quickly, and thus it is also possible to measure a change in the suction pressure and to convert the obtained value into the leakage amount. Furthermore, when controlling the power of the suction apparatus 8, an amount of the power increased necessary to keep the suction pressure constant can be converted into the leakage amount. In Step b5, a set value of the suction pressure for suppressing an increase in the leakage amount accompanying the progress of the cutting is calculated. In Step b6, cutting is started as in Step a12 in FIG. 4.

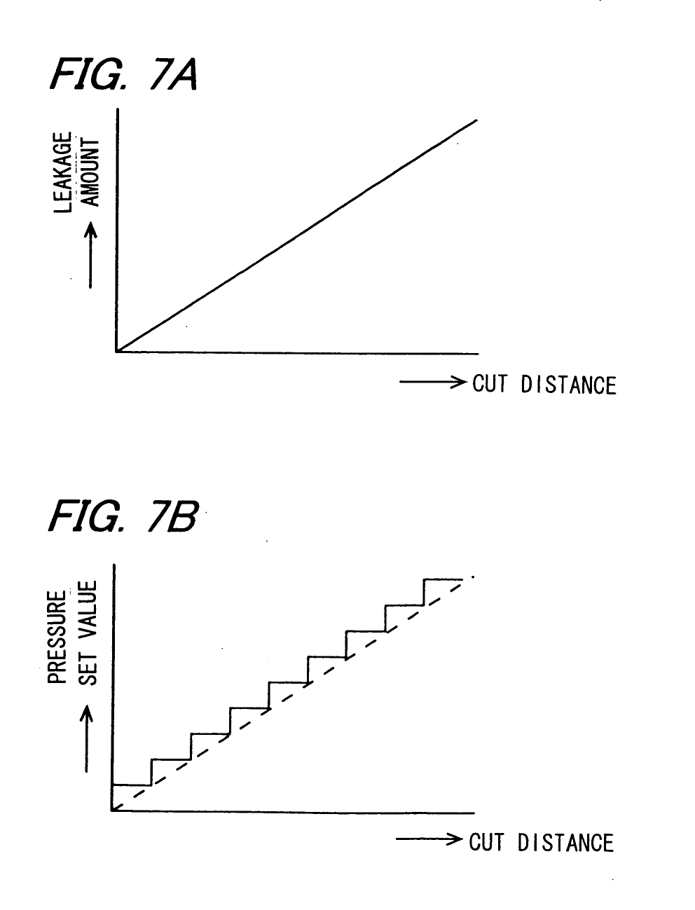

Referring to FIG. 7, FIG. 7A shows an example of the relationship between a cut distance and a leakage amount measured in Step b4 in FIG. 6, and FIG. 7B shows an example of the relationship between set values calculated in Step b5 in FIG. 6 and leakage amounts. As shown in FIG. 7A, the leakage amount increases as the cut distance increases. As shown in FIG. 7B, the suction pressure is adjusted in stages with respect to an increase in the leakage amount. It is preferable that data of control performed in stages in this manner is stored in a data table.

It should be noted that when the sealing sheet 20 is used as a mask, it is possible to calculate a cut distance N with respect to a leakage amount as:
N=L−M

in consideration of a cut distance M of portions that have been already cut but are covered with the sealing sheet 20 with respect to a cut distance L of already-cut portions.

The relationship as shown in FIG. 7 can be obtained by actually cutting the sheet materials 1 that are to be cut sheet by sheet and collecting data, for example. It is possible to perform a simulation sheet by sheet in order to collect reliable data, and to cut a plurality of layered sheets after collecting the data in order to improve the efficiency. Alternatively, it is also possible to acquire data for a plurality of materials during the production of a cutting machine, and to store the data in a database in the storage portion 33 in FIG. 4, for example.

As described above, in the embodiments, it is possible to solve a response problem for example, in a case where suction is adjusted only by feedback control. As a result, the control is open-loop control or feed-forward control, but it goes without saying that the feedback control can be used in combination in order to stabilize the suction pressure.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, when cutting is performed with a cutting machine, an extent of leakage from an already-cut portion is confirmed, and a suction state is adjusted so as to compensate for reduction, due to the leakage, in a holding force on a sheet material on a table. Since fluctuation in the degree of compression of a sheet material is suppressed, it is possible to cut even an elastic sheet material in an appropriate compression state. Since excessive compression due to excessive suction can be avoided, it is possible to improve cutting precision and to save energy.

Furthermore, according to the invention, the suction state is adjusted based on results of a cutting simulation. For example, it is possible to suppress fluctuation in a compression state by performing a simulation while keeping the suction pressure constant and measuring the amount of leakage increased as the cutting progresses, and performing a suction adjustment so as to compensate for the amount of leakage increased.

Furthermore, according to the invention, the suction state is adjusted based on a prediction accompanying the progress of cutting. It is possible to suppress fluctuation in a compression state by predicting the amount of leakage increased based on a cut length of an already-cut portion that increases as the cutting progresses, and performing a suction adjustment so as to compensate for the amount of leakage increased. It is also possible to use results of a cutting simulation and a prediction in combination. It is possible to suppress fluctuation in a compression state of a sheet material accompanying the progress of cutting, by effectively using even results of a simulation with different materials of sheet materials or cutting conditions.

Furthermore, according to the invention, an already-cut portion is covered with a sealing sheet so as to prevent leakage from increasing in the cutting machine. Since the suction state is adjusted in consideration of a covered state with the sealing sheet, it is possible to further suppress fluctuation in a compression state of sheet materials when an increase in the amount of leakage is suppressed as the cutting progresses.

Furthermore, according to the invention, the suction state is adjusted in stages as cutting progresses. It is possible to reduce the control burden by suppressing fluctuation in a compression state of a sheet material within a tolerance range and thereby reducing the number of suction adjustments.

Furthermore, according to the invention, the suction state is adjusted in stages as cutting progresses, taking a part that is cut off a sheet material as a reference. It is possible to perform a suction adjustment at the moment the cutting blade moves apart from the sheet material between parts, for example, and thus the adjustment can be easily arranged.

Furthermore, according to the invention, relation storing means stores a relation obtained by associating in advance a cut distance of an already-cut portion and an adjustment amount of a suction state compensating for an extent of leakage from the already-cut portion. It is possible to store the relation between a cut distance and a correction amount of a suction state as table data or in a database. Since data input means inputs data for cutting a sheet material, it is possible to obtain data used by distance calculating means for calculating an amount of a cut distance increased as cutting progresses. Adjustment amount calculating means calculates an adjustment amount of a suction state, in accordance with an amount of a cut distance increased calculated by the distance calculating means, and based on a relation between the cut distance and the adjustment amount of the suction state, referring to the relation storing means. It is possible to cut even an elastic sheet material in an appropriate compression state, by suppressing fluctuation in the degree of compression of the sheet material.

Furthermore, according to the invention, the cutting machine is provided with mask covering means for covering an already-cut portion with a sealing sheet so as to prevent leakage from increasing. The suction adjustment apparatus further comprises mask calculating means for calculating a cut distance of a portion that is covered with the sealing sheet of the mask covering means, of the already-cut portion. Thus, it is possible to reliably obtain a cut distance of a portion that is covered with the sealing sheet. The adjustment amount calculating means corrects an amount of a cut distance increased calculated by the distance calculating means, with a cut distance of a portion that is covered with the sealing sheet calculated by the mask calculating means. Since an amount of a cut distance increased for calculating an adjustment amount of a suction state is corrected, it is possible to perform an appropriate suction adjustment in a case where a sealing sheet is used.

Furthermore, according to the invention, adjustment amount display means displays an adjustment amount of a suction state calculated by the adjustment amount calculating means, in association with the progress of cutting of a sheet material, and thus it is possible to clearly display a set state in the suction adjustment. Since modification input means inputs a modification of an adjustment amount with respect to the adjustment amount displayed by the adjustment amount display means, it is possible to accept a modification that is input by, for example, a skilled operator. Since adjustment amount modifying means modifies an adjustment amount based on input of the modification input means, it is possible to manually modify an adjustment amount that is automatically set, and thus it is possible to perform a more appropriate suction adjustment in consideration of various conditions.

Furthermore, according to the invention, it is possible to let a computer read a program so as to function as the suction adjustment apparatus, of the cutting machine, according to any one of the above-described aspects. For example, it is possible to obtain control data with which fluctuation in the degree of compression of a sheet material is suppressed, and thus it is possible to cut even an elastic sheet material in an appropriate compression state.

1.-10. (canceled)

11. A method for adjusting suction of a cutting machine when cutting is performed with the cutting machine in which a sheet material is sucked and held on a table and a cutting blade is moved with respect to the table based on preset data, comprising:
while an already-cut portion is covered with a sealing sheet so as to prevent leakage from increasing,
as cutting progresses, confirming an extent of leakage from an already-cut portion, and adjusting a suction state so as to compensate for reduction, due to the leakage, in a holding force on the sheet material on the table, and in consideration of a covered state with the sealing sheet.

12. The method of claim 11, wherein the suction state is adjusted based on results of a cutting simulation.

13. The method of claim 11, wherein the suction state is adjusted based on a prediction accompanying the progress of cutting.

14. The method of claim 11, wherein the suction state is adjusted in stages as cutting progresses.

15. The method of claim 14, wherein the suction state is adjusted in stages as cutting progresses, taking a part that is cut off a sheet material as a reference.

16. A suction adjustment apparatus, of a cutting machine, for adjusting a suction state, when a sheet material is cut by moving a cutting blade based on preset data in the cutting machine in which a sheet material is sucked and held on a table, comprising:
mask covering means for covering an already-cut portion with a sealing sheet so as to prevent leakage from increasing;
suction amount adjustment means for confirming an extent of leakage from an already-cut portion, and adjusting a suction state so as to compensate for reduction, due to the leakage, in a holding force on the sheet material on the table, and in consideration of a covered state with the sealing sheet.

17. The suction adjustment apparatus of claim 16, wherein the suction amount adjustment means comprises:
relation storing means for storing a relation obtained by associating in advance a cut distance of an already-cut portion and an adjustment amount of a suction state compensating for an extent of leakage from the already-cut portion;
data input means for inputting data for cutting a sheet material;
distance calculating means for calculating an amount of a cut distance increased as cutting progresses, based on data input by the data input means; and
adjustment amount calculating means for calculating an adjustment amount of a suction state, in accordance with an amount of a cut distance increased calculated by the distance calculating means, and based on a relation between the cut distance and the adjustment amount of the suction state, referring to the relation storing means.

18. The suction adjustment apparatus of claim 17, further comprising mask calculating means for calculating a cut distance of a portion that is covered with the sealing sheet of the mask covering means, of the already-cut portion,
wherein the adjustment amount calculating means obtains an amount of a cut distance increased for calculating an adjustment amount of the suction state, by correcting an amount of a cut distance increased calculated by the distance calculating means, with a cut distance of a portion that is covered with the sealing sheet calculated by the mask calculating means.

19. The suction adjustment apparatus of claim 17, further comprising:
adjustment amount display means for displaying an adjustment amount of a suction state calculated by the adjustment amount calculating means, in association with the progress of cutting of a sheet material;
modification input means for inputting a modification of an adjustment amount with respect to the adjustment amount displayed by the adjustment amount display means; and
adjustment amount modifying means for modifying an adjustment amount based on input of the modification input means.

20. A program for letting a computer function as the suction adjustment apparatus of the cutting machine according to claim 16.
